(19) United States
(12) Patent Application Publication
(10) Pub. No.: US 2025/0367601 A1
(43) Pub. Date: Dec. 4, 2025

(54) CATALYSTS FOR SELECTIVE NITROGEN OXIDE REDUCTION AND ITS MANUFACTURING METHOD

(71) Applicant: University-Industry Cooperation Group of Kyung Hee University, Yongin-si (KR)

(72) Inventor: Jongsik KIM, Seongnam-si (KR)

(21) Appl. No.: 18/830,097

(22) Filed: Sep. 10, 2024

(30) Foreign Application Priority Data
May 29, 2024 (KR) 10-2024-0069797

(51) Int. Cl. B01D 53/86; B01J 27/18; B01J 37/02; B01J 37/04; B01J 37/20; B01J 37/28

(52) U.S. Cl. CPC B01D 53/8628; B01J 27/18; B01J 37/0215; B01J 37/04; B01J 37/20; B01J 37/28; B01D 2255/2063; B01D 2255/20723; B01D 2255/2073; B01D 2255/20746; B01D 2255/20753; B01D 2255/40; B01D 2257/404

(57) ABSTRACT

Embodiments relate to a metal vanadate catalyst for nitrogen oxide reduction functionalized with H_{3-A}PO₄^{A-} (A=1, 2, or 3) and SO_{B}²⁻ (B=3 or 4) and a synthesis method thereof, and more particularly, to a solid-state catalyst for nitrogen oxide reduction, including a transition metal vanadate or a rare-earth metal vanadate as a catalytic site in a support, some of the catalytic sites being modified with H_{3-A}PO₄^{A-} and SO_{B}²⁻ functional groups, and a synthesis method thereof.

### CROSS-REFERENCE TO RELATED APPLICATION

This application claims the priority to and the benefit of Korean Patent Application No. 10-2024-0069797 filed on May 29, 2024, in the Korean Intellectual Property Office, the disclosure of which is incorporated herein by reference in its entirety.

### BACKGROUND

### 1. Field of the Invention

The present invention relates to a metal vanadate catalyst for nitrogen oxide reduction functionalized with H_{3-A}PO₄^{A-} (A=1, 2, or 3) and SO_{B}²⁻ (B=3 or 4) and a synthesis method thereof, and more particularly, to a solid-state catalyst for nitrogen oxide reduction, including a transition metal vanadate or a rare-earth metal vanadate as a catalytic site in a support, some of the catalytic sites being modified with H_{3-A}PO₄^{A-} and SO_{B}²⁻ functional groups, and a synthesis method thereof.

### 2. Discussion of Related Art

Selective catalytic nitrogen oxides (NO_{X}) reduction (SCR) reaction, which converts anthropogenic NO_{X}, one of the main causes of secondary particulate matter formation, into N₂, which is harmless to the human body, is performed through Reaction Formulas (1) and (2).

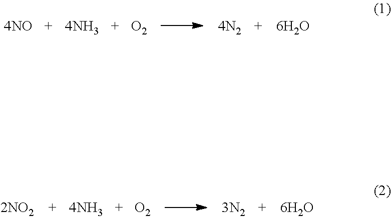

The improvement of the performance, stability, and sustainability of the SCR reaction is possible through the modification of the surface properties of the catalyst used in the SCR reaction. For example, a representative commercial catalyst applied in the SCR process of power plants, sintering reactors, low- and high-speed ships, and cement plants is a TiO₂-based composite oxide which contains one or more vanadium oxide (V oxide) selected from V₂O₃, VO₂, and V₂O₅ as a catalytic site and to which a tungsten oxide promoter site (WO₃) is added. One of the methodologies for modifying the surface properties of a commercial catalyst is the structural modification of the vanadium oxide applied as a catalytic site of the commercial catalyst. For example, a metal vanadate formed by the chemical fusion of a vanadium oxide and a transition metal (TM) or rare-earth metal (RM) oxide may be preferable as a catalytic site for the SCR reaction. Metal vanadates are oxides based on a vanadium-oxygen-metal channel in which vanadium and a TM or vanadium and an RM are combined via oxygen, and they may overcome one or more of the limitations of the vanadium oxide catalyst sites described below.

Specifically, metal vanadates may improve at least one of the following: 1) the aggregation of catalytic sites during the SCR reaction due to the low melting point of vanadium oxide; 2) relatively weak redox cycling trait; 3) relatively small amount of Brønsted acid sites or Lewis acid sites; 4) a decrease in the SCR reaction efficiency per unit time due to the weak interaction between NH₃/NO_{X} and acid sites/redox sites or the strong interaction between H₂O and acid sites/redox sites; and 5) the absence of fast SCR reaction at low temperatures (Reaction Formula (3)). In addition, metal vanadates may overcome at least one of the following problems: 6) poor resistance of vanadium oxide to catalyst surface poisoning by SO₂ contained in exhaust gas; 7) poor resistance to catalyst surface poisoning by ammonium sulfate ((NH₄)₂SO₄, AS)/ammonium bisulfate ((NH₄)HSO₄, ABS) formed by a series of chemical reactions set forth in Reaction Formulas (4) to (6); 8) poor resistance to catalyst surface poisoning by alkali-metal-based compounds contained in exhaust gas; and 9) poor resistance to hydrothermal aging.

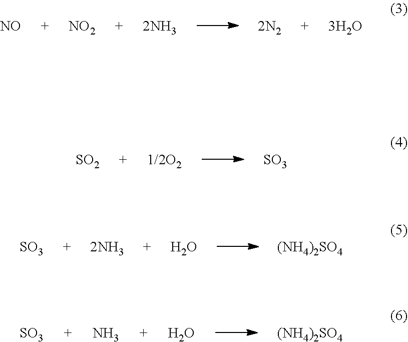

Specifically, TM vanadates (TM)_{X}V₂O_{X+5}(TM=Mn, Co, Ni, or Cu; X=1, 2, or 3), may improve one or more of the limitations (Nos. 1 to 7 above) of vanadium oxide, which is a catalytic site of a commercial catalyst; RM vanadates (RM)VO₄ (RM=La, Ce, Nd, Sm, Gd, Tb, or Er), may improve one or more of the limitations (Nos. 8 to 9 above) of vanadium oxide, which is a catalytic site of a commercial catalyst; and an RM vanadate LaV₃O₉ may improve one or more of the limitations (Nos. 1 to 9 above) of vanadium oxide, which is a catalytic site of a commercial catalyst.

However, despite the various advantages that the above metal vanadates can have as a catalytic site of SCR catalysts, previous reports have been limited to 1) applying a catalyst synthesized by dispersing a metal vanadate on a support such as TiO₂ to the SCR reaction as it is, or 2) applying the catalyst to the SCR reaction in a form modified with only one functional group selected from H_{3-A}PO₄^{A-} or SO_{B}²⁻.

### SUMMARY OF THE INVENTION

The present invention has been made to solve the above-described problems, and one object of the present invention is to utilize the advantages provided by the metal vanadates as catalytic sites to enhance the operability of the SCR reaction, while further improving them. Specifically, the object is to improve the SCR reaction performance and the resistance of the catalyst by functionalizing the surface of the metal vanadates with H_{3-A}PO₄^{A-} (A=1, 2, or 3) and SO_{B}²⁻ (B=3 or 4).

In addition, another object is to provide a method for synthesizing solid-state catalysts for SCR reaction, including one or more crystal phases of TM vanadate or RM vanadate as a catalytic site, and functionalizing some of the catalytic sites using H_{3-A}PO₄^{A-} and SO_{B}²⁻.

In addition, still another object of the present invention is to provide a synthesis method of a solid-phase catalyst for SCR reaction having improved acid characteristics, redox cycling characteristics, and resistance to poisons (H₂O, SO₂, AS/ABS, alkali-metal) and hydro-thermal aging, by including oxides of Group 15 and Group 16 elements as promoter sites on the surface of a metal vanadate catalyst functionalized with H_{3-A}PO₄^{A-} and SO_{B}²⁻.

The technical tasks to be achieved by the present invention are not limited to the above-mentioned technical tasks, and other technical problems not mentioned may be clearly understood by one of ordinary skill in the art to which the present invention pertains, from the description below.

As a technical means for achieving the above-described technical tasks, one aspect of the present invention provides a catalyst for nitrogen oxide reduction, including: a catalyst site including one or more represented by Chemical Formulas 1 to 3 below; and a support on which the catalyst site is supported; wherein the catalyst site is functionalized with H_{3-A}PO₄^{A-} (A=1, 2, or 3) and SO_{B}²⁻ (B=3 or 4):

### [Chemical Formula 1]

(TM)_{X}V₂O_{X+5} (X is 1, 2, or 3; TM is one or more selected from the group consisting of Mn, Co, Ni, and Cu)

### [Chemical Formula 2]

(RM)VO₄ (RM is one or more selected from the group consisting of La, Ce, Pr, Nd, Pm, Sm, Eu, Gd, Tb, Dy, Ho, Er, Tm, Yb, and Lu)

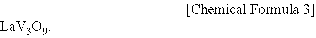

The catalyst may further include a promoter site, which is an oxide of a Group 15 or 16 element, on the support.

The promotor site may be included in an amount of 10⁻⁵% by weight to 50% by weight based on the support.

The Group 15 or 16 element may be included in a combination of one or more of nitrogen (N), phosphorus (P), sulfur (S), arsenic (As), selenium (Se), antimony (Sb), tellurium (Te), bismuth (Bi), polonium (Po), moscovium (Mc), and livermorium (Lv).

The support may include one of carbon (C), Al₂O₃, MgO, ZrO₂, CeO₂, TiO₂, and SiO₂.

The transition metal vanadate or rare-earth metal vanadate represented by one or more of the Chemical Formulas 1 to 3 may include a TM or an RM, each of which may be included in an amount of 10⁻⁵% by weight to 50% by weight based on 100% by weight of the support.

The support may have a porous structure.

The catalytic site may be a vanadate composed of Ni, V, and O; wherein an M/V molar ratio may be 0.5 or more and 1.5 or less; a P/(Sb+M+V) molar ratio may be 10⁻² or more and 1.0 or less; and a S/(Sb+M+V) molar ratio may be 10⁻² or more and 1.0 or less, and the M may be Ni.

The catalytic site may be a vanadate composed of Mn, V, and O; wherein an M/V molar ratio may be 0.5 or more and 1.5 or less; a P/(Sb+M+V) molar ratio may be 10⁻² or more and 1.0 or less; and a S/(Sb+M+V) molar ratio may be 10⁻² or more and 1.0 or less, and the M may be Mn.

The catalytic site may be a vanadate composed of Co, V, and O; wherein an M/V molar ratio may be 0.5 or more and 1.5 or less; a P/(Sb+M+V) molar ratio may be 10⁻² or more and 1.0 or less; and a S/(Sb+M+V) molar ratio may be 10⁻² or more and 1.0 or less, and the M may be Co.

The catalytic site may be a vanadate composed of La, V, and O; wherein an M/V molar ratio may be 0.3 or more and 1.5 or less; a P/(Sb+M+V) molar ratio may be 10⁻² or more and 1.0 or less; and a S/(Sb+M+V) molar ratio may be 10⁻² or more and 1.0 or less, and the M may be La.

Another aspect of the present invention provides a synthesis method of a catalyst for nitrogen oxide reduction, the method including: preparing a mixed solution by mixing a vanadium precursor solution and a rare-earth metal or transition metal precursor solution; inputting a support to the mixed solution; obtaining a solid after the inputting, and performing calcination; and functionalizing a part of a rare-earth metal vanadate or a transition metal vanadate represented by at least one of Chemical Formulas 1 to 3 below with H_{3-A}PO₄^{A-} (A=1, 2, or 3) and SO_{B}²⁻ (B=3 or 4):

### [Chemical Formula 1]

(TM)_{X}V₂O_{X+5} (X is 1, 2, or 3; TM is one or more selected from the group consisting of Mn, Co, Ni, and Cu)

### [Chemical Formula 2]

(RM)VO₄ (RM is one or more selected from the group consisting of La, Ce, Pr, Nd, Pm, Sm, Eu, Gd, Tb, Dy, Ho, Er, Tm, Yb, and Lu)

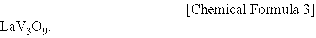

The functionalizing with H_{3-A}PO₄^{A-} may be performed by a reaction gas containing PH₃ and O₂.

The concentrations of PH₃ and O₂ in the reaction gas may have ranges of 10 ppm to 10⁵ ppm.

The functionalizing with H_{3-A}PO₄^{A-} may be performed at a flow rate of 10⁻⁵ mL·min⁻¹ to 10⁵ mL·min⁻¹ under pressure conditions of 10⁻⁵ bar to 10⁵ bar at a temperature of 100° C. to 800° C. for 0.1 to 24 hours.

The functionalizing with H_{3-A}PO₄^{A-} may consist of stirring and drying a synthetic solvent and the catalyst, wherein the synthetic solvent may include one or more of phosphoric acid (H₃PO₄), ammonium phosphate ((NH₄)₃PO₄), ammonium monohydrogen phosphate ((NH₄)₂HPO₄), ammonium dihydrogen phosphate (NH₄H₂PO₄), dimethyl phosphite ((CH₃O)₂HPO), diethyl phosphite ((C₂H₅O)₂HPO), trimethyl phosphite ((CH₃O)₃P), triethyl phosphite ((C₂H₅O)₃P), triisopropyl phosphite ((C₃H₇)₃P), and triphenyl phosphite ((C₆H₅O)₃P).

The concentration of a phosphoric acid precursor contained in the synthetic solvent may have a range of 10⁻⁵ mol·L⁻¹ to 10⁵ mol·L⁻¹.

The stirring may be performed for 0.1 to 24 hours.

The functionalizing with SO_{B}²⁻ may be performed by a reaction gas containing SO₂ and O₂.

The concentrations of SO₂ and O₂ in the reaction gas may have ranges of 10 ppm to 10⁵ ppm.

The functionalizing with SO_{B}²⁻ may be performed at a flow rate of 10⁵ mL·min⁻¹ to 10⁵ mL·min⁻¹ under pressure conditions of 10⁻⁵ bar to 10⁵ bar at a temperature of 100° C. to 800° C. for 0.1 to 24 hours.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 shows high-resolution transmission electron microscopy (HRTEM) photographs of Comparative Examples 1 to 3 and Examples 1 to 7 according to an embodiment of the present invention;

FIG. 2 shows selected area electron diffraction (SAED) pattern photographs of Comparative Examples 1 to 3 and Examples 1 to 7 according to an embodiment of the present invention;

FIG. 3 shows HRTEM photographs of Comparative Examples 4 to 6 and Examples 8 to 10 according to an embodiment of the present invention;

FIG. 4 shows SAED pattern photographs of Comparative Examples 4 to 6 and Examples 8 to 10 according to an embodiment of the present invention; and

FIGS. 5 to 14 show graphs illustrating NO_{X} conversion under various selective catalytic nitrogen oxides (NO_{X}) reduction (SCR) conditions of catalysts synthesized according to Comparative Examples and Examples according to an embodiment of the present invention.

### DETAILED DESCRIPTION OF EXEMPLARY EMBODIMENTS

Hereinafter, the present invention will be described in more detail. However, the present invention may be implemented in various different forms and the present invention is not limited to the embodiments described herein, and the present invention is only defined by the claims that will be described later.

In addition, the terms used herein are only used to describe specific embodiments and are not intended to limit the present invention. Unless the context clearly indicates otherwise, the singular expression includes the plural expression. Throughout the specification of the present invention, unless otherwise specified, the term “comprising” means that other components may be included rather than meaning that other components are excluded.

Throughout the specification, when a portion is described to be “connected (linked, contacted, joined)” to another portion, this includes not only cases where it is “directly connected” but also cases where it is “indirectly connected” with another member therebetween. Also, when a portion is described to “comprise” a certain component, unless otherwise specified, this means that other components may be included rather than meaning that other components are excluded.

The terms used herein are only used to describe specific embodiments and are not intended to limit the present invention. Unless the context clearly indicates otherwise, the singular expression includes the plural expression.

A first aspect of the present invention provides a catalyst for nitrogen oxide reduction, including: a catalyst site including one or more represented by Chemical Formulas 1 to 3 below; and a support on which the catalyst site is supported; wherein the catalyst site is functionalized with H_{3-A}PO₄^{A-} (A=1, 2, or 3) and SO_{B}²⁻ (B=3 or 4):

### [Chemical Formula 1]

(TM)_{X}V₂O_{X+5} (X is 1, 2, or 3; TM is one or more selected from the group consisting of Mn, Co, Ni, and Cu)

### [Chemical Formula 2]

(RM)VO₄ (RM is one or more selected from the group consisting of La, Ce, Pr, Nd, Pm, Sm, Eu, Gd, Tb, Dy, Ho, Er, Tm, Yb, and Lu)

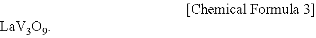

Hereinafter, the catalyst for nitrogen oxide reduction according to the first aspect of the present invention will be described in detail.

In one embodiment of the present invention, the catalyst may further include a promoter site, which is an oxide of a Group 15 or 16 element, on the support.

In one embodiment of the present invention, the promotor site may be included in an amount of 10⁻⁵% by weight to 50% by weight based on the support.

In one embodiment of the present invention, the Group 15 or 16 element may be included in a combination of one or more of nitrogen (N), phosphorus (P), sulfur (S), arsenic (As), selenium (Se), antimony (Sb), tellurium (Te), bismuth (Bi), polonium (Po), moscovium (Mc), and livermorium (Lv).

In one embodiment of the present invention, the support may include one of carbon (C), Al₂O₃, MgO, ZrO₂, CeO₂, TiO₂, and SiO₂.

In one embodiment of the present invention, the transition metal vanadate or rare-earth metal vanadate represented by one or more of the Chemical Formulas 1 to 3 may include a transition metal (TM) or a rare-earth metal (RM), each of which may be included in an amount of 10⁻⁵% by weight to 50% by weight based on 100% by weight of the support.

In one embodiment of the present invention, the support may have a porous structure.

In one specific embodiment of the present invention, the catalytic site may be a vanadate composed of Ni, V, and O; wherein a Brunauer-Emmett-Teller (BET) surface area may be 65 m²/g or more and 71 or less m²/g; an M/V molar ratio may be 0.5 or more and 1.5 or less; a P/(Sb+M+V) molar ratio may be 10⁻² or more and 1.0 or less; and an S/(Sb+M+V) molar ratio may be 10⁻² or more and 1.0 or less, and preferably, the catalytic site may be one of NiV₂O₆, Ni₂V₂O₇, and Ni₃V₂O₈. The M may preferably be a TM or an RM, more preferably a TM, and most preferably Ni.

In one specific embodiment of the present invention, the catalytic site may be a vanadate composed of Mn, V, and O; wherein an M/V molar ratio may be 0.5 or more and 1.5 or less; a P/(Sb+M+V) molar ratio may be 10⁻² or more and 1.0 or less; and an S/(Sb+M+V) molar ratio may be 10⁻² or more and 1.0 or less, and preferably, the catalytic site may be one of MnV₂O₆, Mn₂V₂O₇, and Mn₃V₂O₈. The M may preferably be a TM or an RM, more preferably a TM, and most preferably Mn.

In one specific embodiment of the present invention, the catalytic site may be a vanadate composed of Co, V, and O; wherein a BET surface area may be 62 m²/g or more and 66.5 or less m²/g; an M/V molar ratio may be 0.5 or more and 1.5 or less; a P/(Sb+M+V) molar ratio may be 10⁻² or more and 1.0 or less; and an S/(Sb+M+V) molar ratio may be 10⁻² or more and 1.0 or less, and preferably, the catalytic site may be one of CoV₂O₆, Co₂V₂O₇, and Co₃V₂O₈. The M may preferably be a TM or an RM, more preferably a TM, and most preferably Co.

In one specific embodiment of the present invention, the catalytic site may be a vanadate composed of La, V, and O; wherein a BET surface area may be 71 or less m²/g; an M/V molar ratio may be 0.3 or more and 1.0 or less; a P/(Sb+M+V) molar ratio may be 10⁻² or more and 1.0 or less; and an S/(Sb+M+V) molar ratio may be 10⁻² or more and 1.0 or less, and preferably, the catalytic site may be one of LaVO₄ and LaV₃O₉. The M may preferably be a TM or an RM, more preferably a TM, and most preferably La.

A second aspect of the present invention provides a synthesis method of a catalyst for nitrogen oxide reduction, the method including: preparing a mixed solution by mixing a vanadium precursor solution and a rare-earth metal or transition metal precursor solution; inputting a support to the mixed solution; obtaining a solid after the inputting, and performing calcination; and functionalizing a part of a rare-earth metal vanadate or a transition metal vanadate represented by at least one of Chemical Formulas 1 to 3 below with H_{3-A}PO₄^{A-} (A=1, 2, or 3) and SO_{B}²⁻ (B=3 or 4):

### [Chemical Formula 1]

(TM)_{X}V₂O_{X+5} (X is 1, 2, or 3; TM is one or more selected from the group consisting of Mn, Co, Ni, and Cu)

### [Chemical Formula 2]

(RM)VO₄ (RM is one or more selected from the group consisting of La, Ce, Pr, Nd, Pm, Sm, Eu, Gd, Tb, Dy, Ho, Er, Tm, Yb, and Lu)

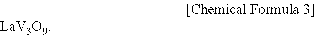

For parts that overlap with the first aspect of the present invention, a detailed description has been omitted, but the contents described for the first aspect of the present invention may be equally applied even when the description has been omitted for the second aspect.

Hereinafter, the synthesis method of a catalyst for nitrogen oxide reduction according to the second aspect of the present invention will be described in detail.

In one embodiment of the present invention, the functionalizing with H_{3-A}PO₄^{A-} may be performed by a reaction gas containing PH₃ and O₂.

In one embodiment of the present invention, the concentrations of PH₃ and O₂ in the reaction gas may have ranges of 10 ppm to 10 ppm.

In one embodiment of the present invention, the functionalizing with H_{3-A}PO₄^{A-} may be performed at a flow rate of 10⁻⁵ mL·min⁻¹ to 10⁵ mL·min⁻¹ under pressure conditions of 10⁻⁵ bar to 10⁵ bar at a temperature of 100° C. to 800° C. for 0.1 to 24 hours.

In one embodiment of the present invention, the functionalizing with H_{3-A}PO₄^{A-} may consist of stirring and drying a synthetic solvent and the catalyst, wherein the synthetic solvent may include one or more of phosphoric acid (H₃PO₄), ammonium phosphate ((NH₄)₃PO₄), ammonium monohydrogen phosphate ((NH₄)₂HPO₄), ammonium dihydrogen phosphate (NH₄H₂PO₄), dimethyl phosphite ((CH₃O)₂HPO), diethyl phosphite ((C₂H₅O)₂HPO), trimethyl phosphite ((CH₃O)₃P), triethyl phosphite ((C₂H₅O)₃P), triisopropyl phosphite ((C₃H₇)₃P), and triphenyl phosphite ((C₆H₅O)₃P).

In one embodiment of the present invention, the stirring may be performed for 0.1 to 24 hours.

In one embodiment of the present invention, the functionalizing with SO_{B}²⁻ may be performed by a reaction gas containing SO₂ and O₂.

In one embodiment of the present invention, the concentrations of SO₂ and O₂ in the reaction gas may have ranges of 10 ppm to 10 ppm.

In one embodiment of the present invention, the functionalizing with SO_{B}²⁻ may be performed at a flow rate of 10⁻⁵ mL·min⁻¹ to 10⁵ mL·min⁻¹ under pressure conditions of 10-5 bar to 10⁵ bar at a temperature of 100° C. to 800° C. for 0.1 to 24 hours.

Hereinafter, examples of the present invention will be described in detail so that those skilled in the art can easily implement the present invention. However, the present invention may be implemented in various different forms and is not limited to the examples described herein.

### Examples 1 to 5: Synthesis of Ni₁—Sb-0.5PS300, Ni₁—Sb-0.25PS300, Ni₁—Sb-1.0PS300, Ni₁—Sb-0.5PS400, and Ni₁—Sb-0.5PS500 Catalysts

Ni₁—Sb-0.5PS300, Ni₁—Sb-0.5PS400, and Ni₁—Sb-0.5PS500, which are Examples 1, 4, and 5, were synthesized by loading Ni₁—Sb-0.5P into a reactor, allowing 500 ppm SO₂ and 3% by volume of O₂ diluted with N₂ to flow into the reactor for one hour under normal pressure at 500 mL·min⁻¹ at 300° C., 400° C., 500° C., respectively, and cooling the resulting products to room temperature in N₂ atmosphere.

Ni₁—Sb-0.25PS300 and Ni₁—Sb-1.0PS300, which are Examples 2 and 3, were synthesized by the same synthesis method as Ni₁—Sb-0.5PS300 of Example 1, except that 0.11 mmol of (NH₄)₂HPO₄ or 0.44 mmol of (NH₄)₂HPO₄ was used instead of 0.22 mmol of (NH₄)₂HPO₄.

### Examples 6 and 7: Synthesis of Ni₂—Sb-0.5PS300 and Ni₃—Sb-0.5PS300 Catalysts

2.36 mmol of NH₄VO₃ and 2.36 mmol of Ni(NO₃)₂·6H₂O were dissolved in 200 mL of distilled water, and the resulting mixture was stirred for one hour, then 5.74 g of Sb₂O₅TiO₂ was added, and the resulting mixture was stirred for 18 hours.

After stirring and dehydrating this, Ni₂—Sb was synthesized by calcination at 500° C. for five hours. In addition, 2.36 mmol of NH₄VO₃ and 3.54 mmol of Ni(NO₃)₂·6H₂O were dissolved in 200 mL of distilled water, and the resulting mixture was stirred for one hour, and then 5.67 g of Sb₂O₅TiO₂ was added, and the resulting mixture was stirred for 18 hours. After stirring and dehydrating this, Ni₃—Sb was synthesized by calcination at 500° C. for five hours. 3 g of Ni₂—Sb or Ni₃—Sb catalyst was added to 140 mL of distilled water in which 0.22 mmol of (NH₄)₂HPO₄ was dissolved, and the resulting mixture was stirred at room temperature for 18 hours. After stirring and dehydrating this, calcination was performed at 500° C. for one hour to synthesize Ni₂—Sb-0.5P or Ni₃—Sb-0.5P. Ni₂—Sb-0.5PS300 or Ni₃—Sb-0.5PS500, which are Examples 6 and 7, were synthesized by loading Ni₂—Sb-0.5P or Ni₃—Sb-0.5P into a reactor, allowing 500 ppm SO₂ and 3% by volume of O₂ diluted with N₂ to flow into the reactor for one hour under normal pressure at 500 mL·min⁻¹ at 300° C., and cooling the resulting product to room temperature in N₂ atmosphere.

### Examples 8 to 10: Synthesis of Mn₁—Sb-0.5PS300·Mn₂—Sb-0.5PS300, and Mn₃—Sb-0.5PS300 catalysts

Mn₁—Sb-0.5PS300, which is Example 8, was synthesized by loading Mn₁—Sb-0.5P, which is Comparative Example 6, into a reactor, allowing 500 ppm SO₂ and 3% by volume of O₂ diluted with N₂ to flow into the reactor for one hour under normal pressure at 500 mL·min⁻¹ at 300° C., and cooling the resulting product to room temperature in N₂ atmosphere. Mn₂—Sb-0.5PS300 and Mn₃—Sb-0.5PS300, which are Examples 9 and 10, were synthesized in the same manner as Ni₂—Sb-0.5PS300 and Ni₃—Sb-0.5PS300 of Examples 6 and 7, except that 2.36 mmol of Mn(NO₃)₂·XH₂O was used instead of 2.36 mmol of Ni(NO₃)₂·6H₂O or 3.54 mmol of Mn(NO₃)₂·XH₂O was used instead of 3.54 mmol of Ni(NO₃)₂·6H₂O.

### Examples 11 to 13: Synthesis of Co₁—Sb-0.5PS300, Co₂—Sb-0.5PS300, and Co₃—Sb-0.5S300 Catalysts

Co₁—Sb-0.5PS300, which is Example 11, was synthesized by loading Co₁—Sb-0.5P, which is Comparative Example 9, into a reactor, allowing 500 ppm SO₂ and 3% by volume of O₂ diluted with N₂ to flow into the reactor for one hour under normal pressure at 500 mL·min⁻¹ at 300° C., and cooling the resulting product to room temperature in N₂ atmosphere. Co₂—Sb-0.5PS300 and Co₃—Sb-0.5PS300, which are Examples 12 and 13, were synthesized in the same manner as Ni₂—Sb-0.5PS300 and Ni₃—Sb-0.5PS300 of Examples 6 and 7, except that 2.36 mmol of Co(NO₃)₂·6H₂O was used instead of 2.36 mmol of Ni(NO₃)₂·6H₂O or 3.54 mmol of Co(NO₃)₂·6H₂O was used instead of 3.54 mmol of Ni(NO₃)₂·6H₂O.

### Examples 14 and 15: Synthesis of LaV—Sb-0.5PS300 and LaV₃—Sb-0.5PS300

LaV—Sb-0.5PS300, which is Example 14, and LaV₃—Sb-0.5PS300, which is Example 15, were synthesized by respectively loading LaV—Sb-0.5P, which is Comparative Example 12, and LaV₃—Sb-0.5P, which is Comparative Example 15, into a reactor, allowing 500 ppm SO₂ and 3% by volume of O₂ diluted with N₂ to flow into the reactor for one hour under normal pressure at 500 mL·min⁻¹ at 300° C., and cooling the resulting product to room temperature in N₂ atmosphere.

### Comparative Examples 1, 4, 7, 10, and 13: Synthesis of: Ni₁—Sb, Mn₁—Sb, Co₁—Sb, LaV—Sb, and LaV₃—Sb Catalysts

48.5 g of TiO₂ was added to 350 mL of an acetic acid solution containing 12.32 mmol of Sb(CH₃COO)₃, and the resulting mixture was stirred and dehydrated, and then calcined at 500° C. for five hours to prepare a TiO₂ support (Sb₂O/TiO₂) on which Sb₂O₅, a promoter site, was dispersed. 2.36 mmol of NH₄VO₃ and 1.18 mmol of Ni(NO₃)₂·6H₂O were dissolved in 200 mL of distilled water, and the resulting mixture was stirred for one hour, and then 5.81 g of Sb₂O₅/TiO₂ was added, and the resulting mixture was stirred for 18 hours. After dehydrating this, the product was calcined at 500° C. for five hours to synthesize Ni₁—Sb, which was named as Comparative Example 1. Mn₁—Sb, which is Comparative Example 4, was synthesized in the same manner as Comparative Example 1, except that 1.18 mmol of Mn(NO₃)₂·XH₂O was used instead of 1.18 mmol of Ni(NO₃)₂·6H₂O. Co₁—Sb, which is Comparative Example 7, was synthesized in the same manner as Comparative Example 1, except that 1.18 mmol of Co(NO₃)₂·6H₂O was used instead of 1.18 mmol of Ni(NO₃)₂·6H₂O. LaV—Sb, which is Comparative Example 10, was synthesized in the same manner as Comparative Example 1, except that 2.36 mmol of La(NO₃)₂·6H₂O was used instead of 1.18 mmol of Ni(NO₃)₂·6H₂O, and 5.55 g of Sb₂O₅/SiO₂ was used instead of 5.81 g of Sb₂O₅/SiO₂. LaV₃—Sb, which is Comparative Example 13, was synthesized in the same manner as Comparative Example 1, except that 0.79 mmol of La(NO₃)₂·6H₂O was used instead of 1.18 mmol of Ni(NO₃)₂·6H₂O, and 5.77 g of Sb₂O₅/TiO₂ was used instead of 5.81 g of Sb₂O₅/TiO₂.

### Comparative Examples 2, 5, 8, 11, and 14: Synthesis of Ni₁—Sb-300S, Mn₁—Sb-300S, Co₁—Sb-300S, LaV—Sb-300S, and LaV₃—Sb-300S Catalysts

Ni₁—Sb-300S, which is Comparative Example 2, Mn₁—Sb-300S, which is Comparative Example 5, Co₁—Sb-300S, which is Comparative Example 8, LaV—Sb-300S, which is Comparative Example 11, and LaV₃—Sb-300S, which is Comparative Example 14, were synthesized by respectively loading the catalysts of Ni₁—Sb, which is Comparative Example 1, Mn₁—Sb, which is Comparative Example 4, Co₁—Sb, which is Comparative Example 7, LaV—Sb, which is Comparative Example 10, and LaV₃—Sb, which is Comparative Example 13, into a reactor, allowing 500 ppm SO₂ and 3% by volume of O₂ diluted with N₂ to flow into the reactor for one hour under normal pressure at 500 mL·min⁻¹ at 300° C., and cooling the resulting product to room temperature in N₂ atmosphere.

### Comparative Examples 3, 6, 9, 12, and 15: Synthesis of Ni₁—Sb-0.5P, Mn₁—Sb-0.5P, Co₁—Sb-0.5P, LaV—Sb-0.5P, and LaV₃—Sb-0.5P Catalysts

3 g of the catalysts of Ni₁—Sb, which is Comparative Example 1, Mn₁—Sb, which is Comparative Example 4, Co₁—Sb, which is Comparative Example 7, LaV—Sb, which is Comparative Example 10, and LaV₃—Sb, which is Comparative Example 13 were added to 140 mL of distilled water in which 0.22 mmol of (NH₄)₂HPO₄ was dissolved, and the resulting mixture was stirred at room temperature for 18 hours. After dehydrating this, the product was calcined at 500° C. for one hour to synthesize Ni₁—Sb-0.5P, which is Comparative Example 3, Mn₁—Sb-0.5P, which is Comparative Example 6, Co₁—Sb-0.5P, which is Comparative Example 9, LaV—Sb-0.5P, which is Comparative Example 12, or LaV₃—Sb-0.5P, which is Comparative Example 15.

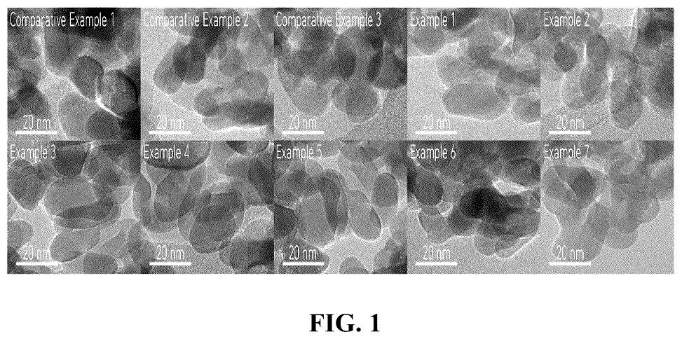

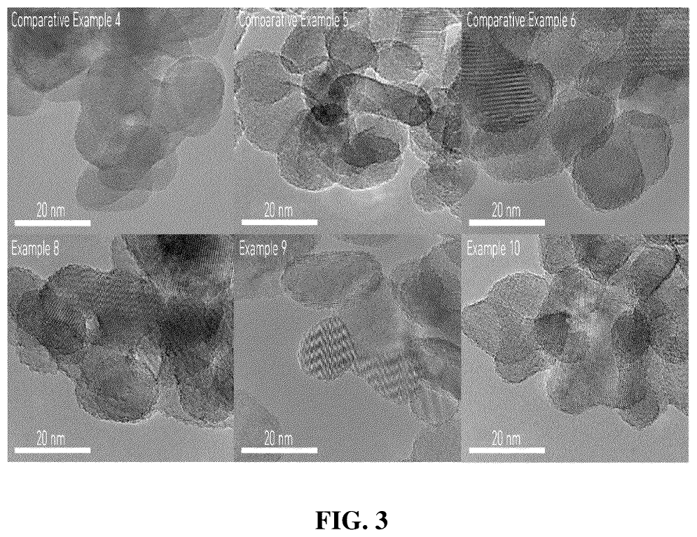

The morphology of the catalysts synthesized in Comparative Examples 1 to 6 and Examples 1 to 10 was analyzed using high-resolution transmission electron microscopy (HRTEM), and the results are shown in FIGS. 1 and 3. Referring to these drawings, it can be seen that the synthesized catalysts exhibit porous characteristics due to TiO₂ agglomerates having a size of several tens to several hundreds of nanometers. To quantify the porosity of the catalysts synthesized in Comparative Examples to 15 and Examples to 15, N₂ physisorption experiments were performed to analyze and present the BET surface area and the Barrett-Joyner-Halenda (BJH) pore volume (Table 1). In addition, the components of the catalysts were analyzed using inductively coupled plasma spectroscopy, and the results are presented in Table 1 below.

TABLE 1

| | | BET | BJH | | P/ | S/ |
|---|---|---|---|---|---|---|
| | Vanadate | surface | pore | | (Sb + | (Sb + |
| | catalytic | area | volume | | M + | M + |
| Catalyst | site | (m² g⁻¹) | (cm³ g⁻¹) | M/V¹ | V)¹ | V)¹ |
| Comparative | NiV₂O₆ | 75.2 | 0.3 | 0.5 | — | — |
| Example 1 | | | | | | |
| Comparative | NiV₂O₆ | 67.6 | 0.3 | 0.5 | — | 0.2 |
| Example 2 | | | | | | |
| Comparative | NiV₂O₆ | 70.1 | 0.3 | 0.5 | 0.1 | — |
| Example 3 | | | | | | |
| Example 1 | NiV₂O₆ | 68.7 | 0.3 | 0.5 | 0.1 | 0.1 |
| Example 2 | NiV₂O₆ | 66.1 | 0.3 | 0.5 | 0.1 | 0.1 |
| Example 3 | NiV₂O₆ | 69.2 | 0.3 | 0.5 | 0.2 | 0.1 |
| Example 4 | NiV₂O₆ | 70.1 | 0.3 | 0.5 | 0.1 | 0.1 |
| Example 5 | NiV₂O₆ | 66.0 | 0.3 | 0.5 | 0.1 | 0.1 |
| Example 6 | Ni₂V₂O₇ | 68.7 | 0.3 | 1.0 | 0.1 | 0.2 |
| Example 7 | Ni₃V₂O₈ | 65.4 | 0.3 | 1.5 | 0.1 | 0.2 |
| Comparative | MnV₂O₆ | 87.8 | 0.3 | 0.5 | — | — |
| Example 4 | | | | | | |
| Comparative | MnV₂O₆ | 63.5 | 0.3 | 0.5 | — | 0.2 |
| Example 5 | | | | | | |
| Comparative | MnV₂O₆ | 69.0 | 0.3 | 0.5 | 0.1 | — |
| Example 6 | | | | | | |
| Example 8 | MnV₂O₆ | 68.9 | 0.3 | 0.5 | 0.1 | 0.1 |
| Example 9 | Mn₂V₂O₇ | 69.0 | 0.3 | 1.0 | 0.1 | 0.2 |
| Example 10 | Mn₃V₂O₈ | 67.3 | 0.3 | 1.5 | 0.1 | 0.2 |
| Comparative | CoV₂O₆ | 67.8 | 0.3 | 0.5 | — | — |
| Example 7 | | | | | | |
| Comparative | CoV₂O₆ | 68.8 | 0.3 | 0.5 | — | 0.2 |
| Example 8 | | | | | | |
| Comparative | CoV₂O₆ | 66.8 | 0.3 | 0.5 | 0.1 | — |
| Example 9 | | | | | | |
| Example 11 | CoV₂O₆ | 68.3 | 0.3 | 0.5 | 0.1 | 0.1 |
| Example 12 | Co₂V₂O₇ | 63.4 | 0.3 | 1.0 | 0.1 | 0.2 |
| Example 13 | Co₃V₂O₈ | 62.4 | 0.3 | 1.5 | 0.1 | 0.2 |
| Comparative | LaVO₄ | 73.7 | 0.3 | 1.0 | — | — |
| Example 10 | | | | | | |
| Comparative | LaVO₄ | 77.3 | 0.3 | 1.0 | — | 0.2 |
| Example 11 | | | | | | |
| Comparative | LaVO₄ | 72.5 | 0.3 | 1.0 | 0.1 | — |
| Example 12 | | | | | | |
| Example 14 | LaVO₄ | 70.6 | 0.3 | 1.0 | 0.1 | 0.2 |
| Comparative | LaV₃O₉ | 75.0 | 0.3 | 0.3 | — | — |
| Example 13 | | | | | | |
| Comparative | LaV₃O₉ | 72.7 | 0.3 | 0.3 | — | 0.2 |
| Example 14 | | | | | | |
| Comparative | LaV₃O₉ | 74.8 | 0.3 | 0.3 | 0.1 | — |
| Example 15 | | | | | | |
| Example 15 | LaV₃O₉ | 69.5 | 0.3 | 0.3 | 0.1 | 0.1 |

¹M is a TM or an RM.

From the BET surface area and BJH pore volume results, it was confirmed that the catalysts synthesized in Comparative Examples 1 to 15 and Examples 1 to 15 had a porous structure. In addition, the V contents of the catalysts were almost the same as 2% by weight based on the total weight of the catalysts. In addition, it was found that the M/V molar ratios of the catalysts of the comparative examples and the examples had values close to the M/V molar ratio of the vanadate inherent in the catalysts. For example, the MN values of the catalysts of Comparative Examples 1 to 3 and Examples 1 to 5 were close to the theoretical Ni/V value of 0.5 for NiV₂O₆, and the MN values of the catalysts of Examples 2 and 3 were close to the theoretical Ni/V values of 1.0 and 1.5 for Ni₂V₂O₇ and Ni₃V₂O₈, respectively. Based on this, it was found that the catalysts of Comparative Examples 1 to 3 and Examples 1 to 5 successfully dispersed NiV₂O₆ on the porous TiO₂ surface, the catalyst of Example 6 successfully dispersed Ni₂V₂O₇ on the porous TiO₂ surface, and the catalyst of Example 7 successfully dispersed Ni₃V₂O₈ on the porous TiO₂ surface.

In addition, it was found that the S/(Sb+M+V) molar ratio of the catalysts synthesized in Comparative Examples 1 to 15 and Examples 1 to 15 (except Comparative Examples 1, 4, 7, 10, and 13) functionalized with H_{3-A}PO₄^{A-} or SO_{B}²⁻ was 0.1 to 0.2, and the P/(Sb+M+V) molar ratio was 0.1 to 0.2, indicating that their values were almost the same. This means that the functionalization of the catalysts synthesized in Comparative Examples 1 to 15 and Examples 1 to 15 (except Comparative Examples 1, 4, 7, 10, and 13) with H_{3-A}PO₄^{A-} or SO_{B}²⁻ was performed to a similar degree.

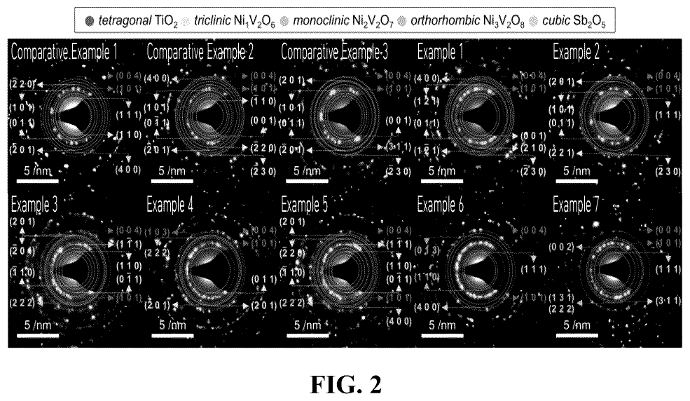

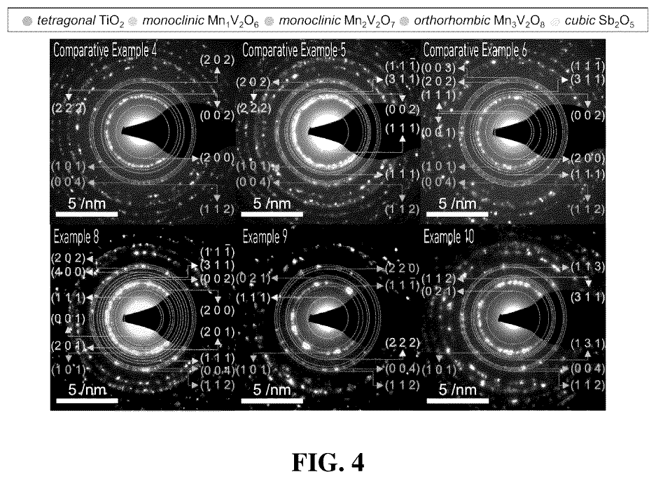

The crystal structures of the catalysts synthesized in Comparative Examples 1 to 6 and Examples 1 to 10 were analyzed using selected area electron diffraction (SAED) patterns, and the results are shown in FIGS. 2 and 4. The SAED patterns of all the synthesized catalysts include crystal planes of cubic Sb₂O₅ and tetragonal TiO₂, which is due to the Sb₂O₅ promoter sites and TiO₂ support inherent in the catalysts.

Referring to the SAED patterns of FIG. 2, the catalysts of Comparative Examples 1 to 3 and Examples 1 to 5 include a crystal plane of triclinic NiV₂O₆, the catalyst of Example 6 includes a crystal plane of monoclinic Ni₂V₂O₇, and the catalyst of Example 7 includes a crystal plane of orthorhombic Ni₃V₂O₈.

Referring to the SAED patterns of FIG. 4, the catalysts of Comparative Examples 4 to 6 and Example 8 include a crystal plane of monoclinic MnV₂O₆, the catalyst of Example 9 includes a crystal plane of monoclinic Mn₂V₂O₇, and the catalyst of Example 10 includes a crystal plane of orthorhombic Mn₃V₂O₈.

As shown in FIGS. 2 and 4, in the SAED of the catalysts synthesized in Comparative Examples 1 to 6 and Examples 1 to 10, no SAED patterns of substances other than the TM vanadates, for example, vanadium oxide or TM oxides, were observed. In other words, it was found that the catalysts synthesized in Comparative Examples 1 to 6 and Examples 1 to 10 of the present invention only contain vanadates, which are oxides in which vanadium oxide and transition metal oxide are fused into one, and do not contain vanadium oxide and transition metal oxide separately.

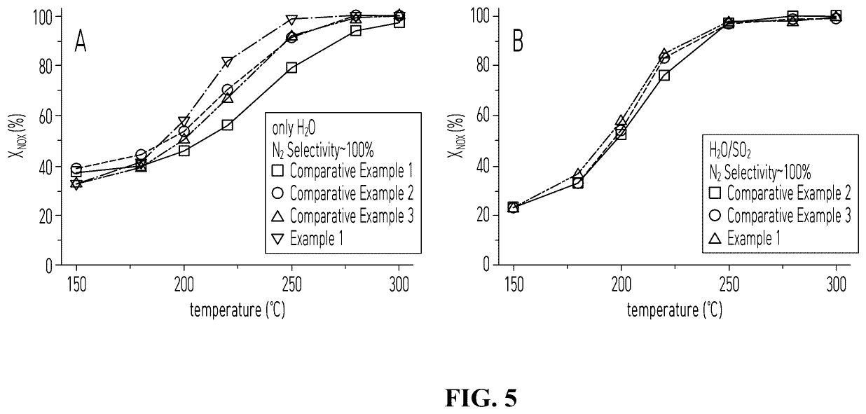

Hereinafter, referring to FIGS. 5 to 14, the SCR reaction performance using the catalysts synthesized in Comparative Examples 1 to 15 and Examples 1 to 15 will be described.

### Experimental Example 1: Performance Analysis of SCR Reaction I

The performance of the SCR reaction in the absence of SO₂ was measured using the catalysts of Comparative Examples 1 to 3 and Example 1. Specifically, the performance of the above-described catalysts was measured in a reaction fluid containing 800 ppm of NO_{X}, 800 ppm of NH₃, 3% by volume of 02, 6% by volume of H₂O, and N₂, which is an inert gas, at a spatial velocity of 60,000 hr⁻¹, and the NO_{X} conversion (X_{NOX}) results are shown in FIG. 5A. All the catalysts exhibited 100% N₂ selectivity in the temperature range of 150° C. to 300° C. Referring to FIG. 5A, it can be seen that the catalysts of Comparative Example 2 or 3, whose catalyst surfaces were functionalized with SO_{B}²⁻ or H_{3-A}PO₄^{A-}, exhibited larger X_{NOX} values at 150° C. to 300° C. than those of the catalyst of Comparative Examples 1, whose catalyst surfaces were not functionalized. This means that the functionalization of the TM (nickel) vanadate with SO_{B}²⁻ or H_{3-A}PO₄^{A-} is effective in increasing the number of Brønsted acids for NH₃ adsorption, and that the SO_{B}²⁻ or H_{3-A}PO₄^{A-} functional groups are effective in increasing the redox cycling characteristics of the catalyst surface. In addition, it can be seen that the catalyst of Example 1 functionalized with SO_{B}²⁻ and H_{3-A}PO₄^{A-} exhibited larger X_{NOX} values at 150° C. to 300° C. than those of the catalysts of Comparative Example 1, 2, or 3, which were unfunctionalized, functionalized with SO_{B}²⁻ or functionalized with H_{3-A}PO₄^{A-} This means that the SO_{B}²⁻ and H_{3-A}PO₄^{A-} functional groups inherent on the surface of the TM (nickel) vanadate have a synergistic effect in increasing the number of Brønsted acids for NH₃ adsorption and increasing the redox cycling characteristics of the catalyst surface. In addition, the performance of the SCR reaction in the presence of SO₂ was measured using the catalysts of Comparative Examples 2 and 3 and Example 1. Specifically, the performance of the above-described catalysts was measured in a reaction fluid containing 800 ppm of NO_{X}, 800 ppm of NH₃, 500 ppm of SO₂, 3% by volume of 02, 6% by volume of H₂O, and N₂, which is an inert gas, at a spatial velocity of 60,000 hr⁻¹, and the NO_{X} conversion (X_{NOX}) results are shown in FIG. 5B. All the catalysts exhibited 100% N₂ selectivity in the temperature range of 150° C. to 300° C. Referring to FIG. 5B, it can be seen that the catalyst of Comparative Example 3 functionalized with H_{3-A}PO₄^{A-} and the catalyst of Example 1 functionalized with SO_{B}²⁻ and H_{3-A}PO₄^{A-} exhibited larger X_{NOX} values at 150° C. to 300° C. than those of the catalyst of Comparative Example 2 functionalized with SO_{B}²⁻. This means that the catalyst surface including the H_{3-A}PO₄^{A-} functional group may be preferable for increasing the resistance to SO₂. On the other hand, although the catalyst of Example 1 functionalized with SO_{B}²⁻ and H_{3-A}PO₄^{A-} exhibited increased X_{NOX} values compared to the catalyst of Comparative Example 3 functionalized with H_{3-A}PO₄^{A-} at 180° C. to 200° C., the X_{NOX} values of the two catalysts were similar in the temperature range of 150° C. to 300° C. This means that in order to maximize the synergistic effect of SO_{B}²⁻ and H_{3-A}PO₄^{A-} inherent in the catalyst surfaces, it is important to preferably control and select the functionalization conditions of SO_{B}²⁻ and H_{3-A}PO₄^{A-}, such as the type of TM vanadate, the concentrations of SO_{B}²⁻ and H_{3-A}PO₄^{A-} precursors (SO₂/O₂ and (NH₄)₂HPO₄), and the exposure time/exposure temperature to the catalyst surfaces.

### Experimental Example 2: Performance Analysis of SCR Reaction II

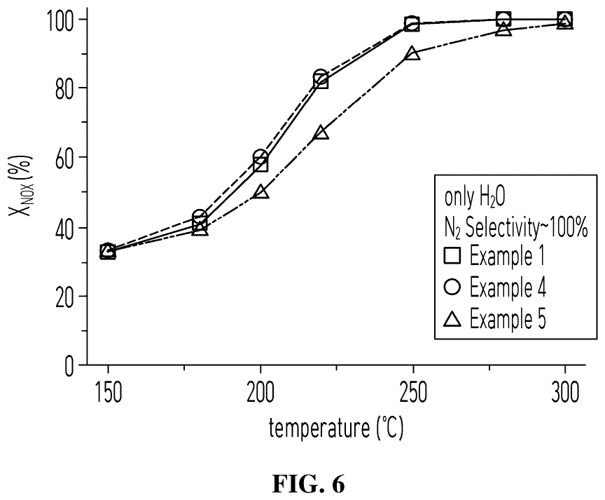

The performance of the SCR reaction in the absence of SO₂ was measured using the catalysts of Comparative Example 1 and Examples 1 to 3. Specifically, the performance of the above-described catalysts was measured under the same conditions as in FIG. 5A of Experimental Example 1, and the nitrogen oxide conversion (NO_{X} conversion, X_{NOX}) results are shown in FIG. 6. All the catalysts exhibited 100% N₂ selectivity in the temperature range of 150° C. to 300° C. Referring to FIG. 6, it can be seen that the catalysts of Examples 1 to 3, whose catalyst surfaces were functionalized with SO_{B}²⁻ and H_{3-A}PO₄^{A-} exhibited larger X_{NOX} values at 150° C. to 300° C. than those of the catalyst of Comparative Example 1, whose catalyst surface was not functionalized. This means that the functionalization of the TM (nickel) vanadate with SO_{B}²⁻ and H_{3-A}PO₄^{A-} is effective in increasing the number of Brønsted acids for the adsorption of NH₃, and that the SO_{B}²⁻ and H_{3-A}PO₄^{A-} functional groups are effective in increasing the redox cycling characteristics of the catalyst surface. In addition, in the cases of Example 1 (Ni₁—Sb-0.5PS300), Example 2 (Ni₁—Sb-0.25PS300), and Example 3 (Ni₁—Sb-1.0PS300), which were functionalized with SO_{B}²⁻ and H_{3-A}PO₄^{A-} but with different amounts of H_{3-A}PO₄^{A-}, it was found that the X_{NOX} values increased in the order of Example 3<Example 1<Example 2 at 250° C. This means that the synergistic effect of the SO_{B}²⁻ and H_{3-A}PO₄^{A-} functional groups inherent on the surface of TM (nickel) vanadate on increasing the number of Brønsted acids for NH₃ adsorption and increasing the redox cycling characteristics of the catalyst surface depends on the number of H_{3-A}PO₄^{A-} functional groups and is maximized in Example 2 (Ni₁—Sb-0.25PS300).

### Experimental Example 3: Performance Analysis of SCR Reaction III

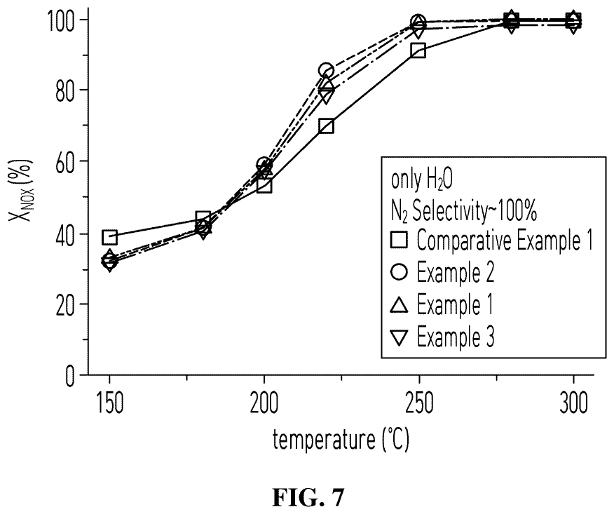

The performance of the SCR reaction in the absence of SO₂ was measured using the catalysts of Examples 1, 4, and 5. Specifically, the performance of the above-described catalysts was measured under the same conditions as in FIG. 5A of Experimental Example 1, and the nitrogen oxide conversion (NO_{X} conversion, X_{NOX}) results are shown in FIG. 7. All the catalysts exhibited 100% N₂ selectivity in the temperature range of 150° C. to 300° C. Referring to FIG. 7, it can be seen that the catalysts of Examples 1 and 4 functionalized with SO_{B}²⁻ at 300° C. and 400° C. exhibited larger X_{NOX} values at 150° C. to 300° C. than those of the catalyst of Example 5 functionalized with SO_{B}²⁻ at 500° C. This means that in order to maximize the synergistic effect of SO_{B}²⁻ and H_{3-A}PO₄^{A-} inherent in the catalyst surface, it is important to select a preferable exposure temperature of SO_{B}²⁻ precursors (SO₂/O₂) to the catalyst surfaces, as a SO_{B}²⁻ functionalization condition.

### Experimental Example 4: Performance Analysis of SCR Reaction VI

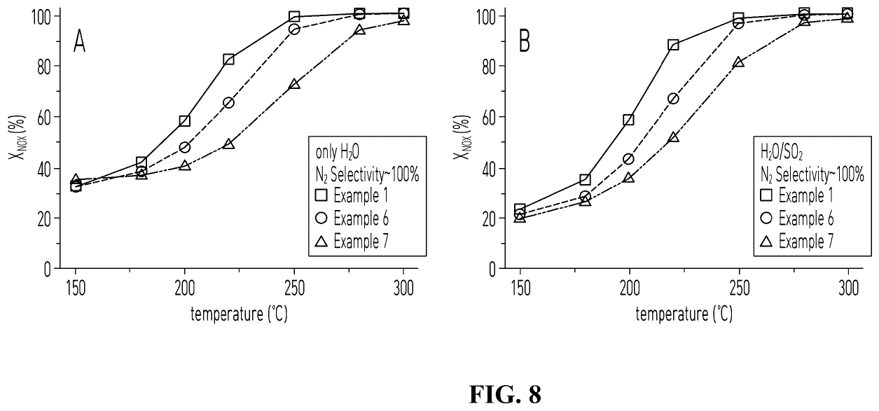

The performance of the SCR reaction in the absence of SO₂ was measured using the catalysts of Examples 1, 6, and 7. Specifically, the performance of the above-described catalysts was measured under the same conditions as in FIG. 5A of Experimental Example 1, and the results of the nitrogen oxide conversion (NO_{X} conversion, X_{NOX}) are shown in FIG. 8A. In addition, the performance of the SCR reaction in the presence of SO₂ was measured using the catalysts of Examples 1, 6, and 7. Specifically, the performance of the above-described catalysts was measured under the same conditions as in FIG. 5B of Experimental Example 1, and the results of the nitrogen oxide conversion (NO_{X} conversion, X_{NOX}) are shown in FIG. 8B. All catalysts exhibited 100% N₂ selectivity in the temperature range of 150° C. to 300° C. Referring to FIGS. 8A and 8B, it can be seen that when the crystal phase of the TM (nickel) vanadate on which the SO_{B}²⁻ and H_{3-A}PO₄^{A-} functional groups are immobilized was NiV₂O₆, the value of X_{NOX} was larger than that of Ni₂V₂O₇, and when the crystal phase was Ni₂V₂O₇, the value of X_{NOX} was larger than that of Ni₃V₂O₈. This means that in order to maximize the synergistic effect of SO_{B}²⁻ and H_{3-A}PO₄^{A-} inherent in the catalyst surfaces, it is important to preferably control and select the crystal phase of the TM (nickel) vanadate on which the functional groups are immobilized.

### Experimental Example 5: Performance Analysis of SCR Reaction V

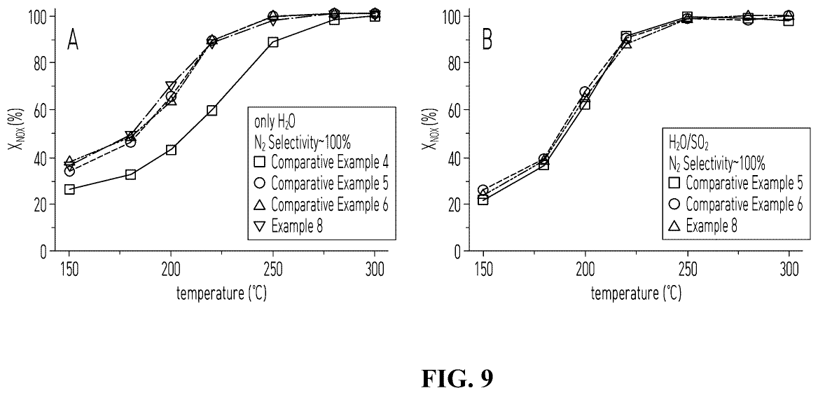

The performance of the SCR reaction in the absence of SO₂ was measured using the catalysts of Comparative Examples 4 to 6 and Example 8. Specifically, the performance of the above-described catalysts was measured under the same conditions as in FIG. 5A of Experimental Example 1, and the nitrogen oxide conversion (NO_{X} conversion, X_{NOX}) results are shown in FIG. 9A. In addition, the performance of the SCR reaction in the presence of SO₂ was measured using the catalysts of Comparative Examples 5 and 6 and Example 8. Specifically, the performance of the above-described catalysts was measured under the same conditions as in FIG. 5B of Experimental Example 1, and the nitrogen oxide conversion (NO_{X} conversion, X_{NOX}) results are shown in FIG. 9B. All catalysts exhibited 100% N₂ selectivity in the temperature range of 150° C. to 300° C. Referring to FIG. 9A, it can be seen that the catalyst of Comparative Example 5 or Comparative Example 6, whose catalyst surface was functionalized with SO_{B}²⁻ or H_{3-A}PO₄^{A-} exhibited larger X_{NOX} values at 150° C. to 300° C. than those of the catalyst of Comparative Example 4, whose catalyst surface was not functionalized. This means that the functionalization of the TM (manganese) vanadate with SO_{B}²⁻ or H_{3-A}PO₄^{A-} is effective in increasing the number of Brønsted acids for NH₃ adsorption, and that the SO_{B}²⁻ or H_{3-A}PO₄^{A-} functional groups are effective in increasing the redox cycling characteristics of the catalyst surface. In addition, it can be seen that the catalyst of Example 8 functionalized with SO_{B}²⁻ and H_{3-A}PO₄^{A-} exhibited a larger X_{NOX} value at 200° C. than that of the catalyst of Comparative Example 4, 5, or 6, which was unfunctionalized, functionalized with SO_{B}², or functionalized with H_{3-A}PO₄^{A-}. This means that the SO_{B}²⁻ and H_{3-A}PO₄^{A-} functional groups inherent on the surface of transition metal (manganese) vanadate have a synergistic effect in increasing the number of Brønsted acids for NH₃ adsorption and increasing the redox cycling characteristics of the catalyst surface. Also, referring to FIG. 9B, it can be seen that the catalyst of Comparative Example 5 functionalized with SO_{B}², the catalyst of Comparative Example 6 functionalized with H_{3-A}PO₄^{A-}, and the catalyst of Example 8 functionalized with SO_{B}²⁻ and H_{3-A}PO₄^{A-} exhibited similar X_{NOX} values at 150° C. to 300° C. This means that in order to maximize the synergistic effect of SO_{B}²⁻ and H_{3-A}PO₄^{A-} inherent on the catalyst surface, it is important to preferably control and select the functionalization conditions of SO_{B}²⁻ and H_{3-A}PO₄^{A-}, for example, the type of TM vanadate, the concentrations of SO_{B}²⁻ and H_{3-A}PO₄^{A-} precursors (SO₂/O₂ and (NH₄)₂HPO₄), and the exposure time/exposure temperature to the catalyst surfaces.

### Experimental Example 6: Performance Analysis of SCR Reaction VI

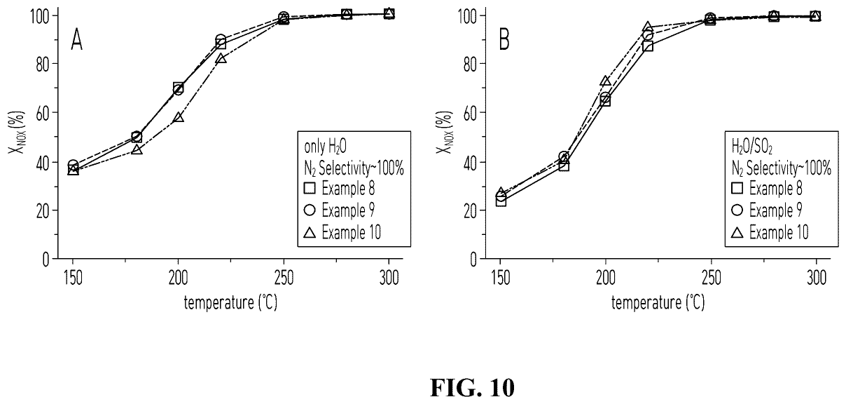

The performance of the SCR reaction in the absence of SO₂ was measured using the catalysts of Examples 8, 9, and 10. Specifically, the performance of the above-described catalysts was measured under the same conditions as in FIG. 5A of Experimental Example 1, and the results of the nitrogen oxide conversion (NO_{X} conversion, X_{NOX}) are shown in FIG. 10A. In addition, the performance of the SCR reaction in the presence of SO₂ was measured using the catalysts of Examples 8, 9, and 10. Specifically, the performance of the above-described catalysts was measured under the same conditions as in FIG. 5B of Experimental Example 1, and the results of the nitrogen oxide conversion (NO_{X} conversion, X_{NOX}) are shown in FIG. 10B. All catalysts exhibited of 100% N₂ selectivity in the temperature range of 150° C. to 300° C. Referring to FIG. 10A, it can be seen that when the crystal phases of the TM (manganese) vanadate on which SO_{B}²⁻ and H_{3-A}PO₄^{A-} functional groups were immobilized were MnV₂O₆ and Mn₂V₂O₇, the values of X_{NOX} in the absence of SO₂ were similar, whereas, when the crystal phase was Mn₃V₂O₈, the value of X_{NOX} in the absence of SO₂ was smaller than that of MnV₂O₆/Mn₂V₂O₇. On the other hand, referring to FIG. 10B, it can be seen that when the crystal phase of the TM (manganese) vanadate on which the SO_{B}²⁻ and H_{3-A}PO₄^{A-} functional groups were immobilized was Mn₃V₂O₈, the value of X_{NOX} in the presence of SO₂ was larger than that of MnV₂O₆/Mn₂V₂O₇. This means that in order to maximize the synergistic effect of SO_{B}²⁻ and H_{3-A}PO₄^{A-} inherent on the catalyst surface under various SCR reaction conditions, it is important to preferably select the crystal phase of the TM (manganese) vanadate on which the functional groups are immobilized.

### Experimental Example 7: Performance Analysis of SCR Reaction VII

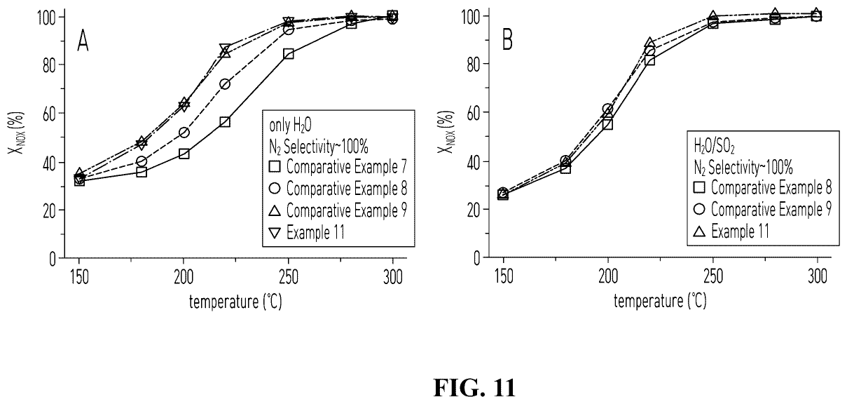

The performance of the SCR reaction in the absence of SO₂ was measured using the catalysts of Comparative Examples 7 to 9 and Example 11. Specifically, the performance of the above-described catalysts was measured under the same conditions as in FIG. 5A of Experimental Example 1, and the nitrogen oxide conversion (NO_{X} conversion, X_{NOX}) results are shown in FIG. 11A. In addition, the performance of the SCR reaction in the presence of SO₂ was measured using the catalysts of Comparative Examples 8 and 9 and Example 11. Specifically, the performance of the above-described catalysts was measured under the same conditions as in FIG. 5B of Experimental Example 1, and the nitrogen oxide conversion (NO_{X} conversion, X_{NOX}) results are shown in FIG. 11B. All catalysts exhibited 100% N₂ selectivity of in the temperature range of 150° C. to 300° C. Referring to FIG. 11A, it can be seen that the catalyst of Comparative Example 8 or Comparative Example 9, whose catalyst surface was functionalized with SO_{B}²⁻ or H_{3-A}PO₄^{A-} exhibited larger X_{NOX} values at 150° C. to 300° C. than those of the catalyst of Comparative Example 7, whose catalyst surface was not functionalized. This means that the functionalization of the TM (cobalt) vanadate with SO_{B}²⁻ or H_{3-A}PO₄^{A-} is effective in increasing the number of Brønsted acids for NH₃ adsorption, and that the SO_{B}²⁻ or H_{3-A}PO₄^{A-} functional groups is effective in increasing the redox cycling characteristics of the catalyst surface. In addition, it can be seen that the catalyst of Example 11, which was functionalized with SO_{B}²⁻ and H_{3-A}PO₄^{A-}, exhibited larger X_{NOX} values at 150° C. to 300° C. than those of the catalysts of Comparative Example 7 or 10 Comparative Example 8, which were unfunctionalized or functionalized with SO_{B}²⁻. This means that the SO_{B}²⁻ and H_{3-A}PO₄^{A-} functional groups inherent on the surface of the TM (cobalt) vanadate may exhibit a synergistic in increasing the number of Brønsted acids for NH₃ adsorption and increasing the redox cycling characteristics of the catalyst surface. On the other hand, referring to FIG. 11A, it can be seen that the catalyst of Example 11 functionalized with SO_{B}²⁻ and H_{3-A}PO₄^{A-} exhibited similar X_{NOX} values at 150° C. to 300° C. to the catalyst of Comparative Example 9 functionalized with H_{3-A}PO₄^{A-}. In addition, referring to FIG. 11B, it can be seen that the catalyst of Comparative Example 9 functionalized with H_{3-A}PO₄^{A-} and the catalyst of Example 11 functionalized with SO_{B}²⁻ and H_{3-A}PO₄^{A-} exhibited larger X_{NOX} values at 150° C. to 300° C. than those of the catalyst of Comparative Example 8 functionalized with SO_{B}²⁻. Nevertheless, referring to FIG. 11B, it can be seen that the catalyst of Comparative Example 9 functionalized with H_{3-A}PO₄^{A-} and the catalyst of Example 11 functionalized with SO_{B}²⁻ and H_{3-A}PO₄^{A-} exhibited similar X_{NOX} values at 150° C. to 300° C. This means that in order to maximize the synergistic effect of SO_{B}²⁻ and H_{3-A}PO₄^{A-} inherent on the catalyst surface, it is important to preferably control and select the functionalization conditions of SO_{B}²⁻ and H_{3-A}PO₄^{A-} such as the type of TM vanadate, the concentrations of SO_{B}²⁻ and H_{3-A}PO₄^{A-} precursors (SO₂/O₂ and (NH₄)₂HPO₄), and the exposure time/exposure temperature to the catalyst surfaces.

### Experimental Example 8: Performance Analysis of SCR Reaction VIII

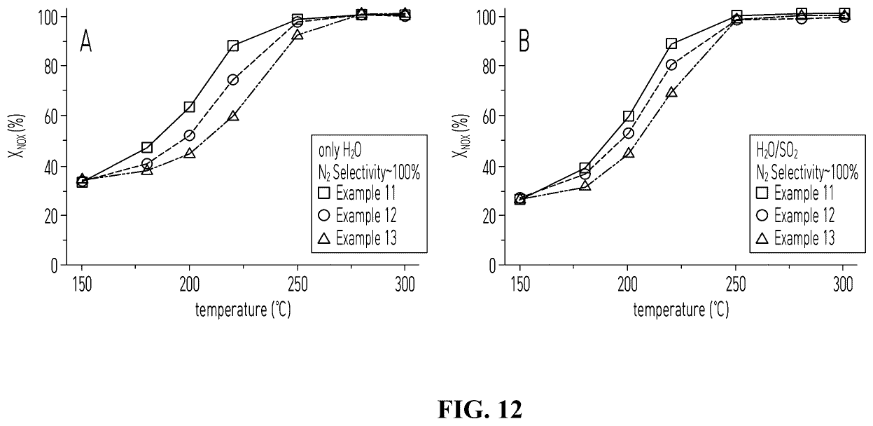

The performance of the SCR reaction in the absence of SO₂ was measured using the catalysts of Examples 11, 12, and 13. Specifically, the performance of the above-described catalysts was measured under the same conditions as in FIG. 5A of Experimental Example 1, and the results of the nitrogen oxide conversion (NO_{X} conversion, X_{NOX}) are shown in FIG. 12A. In addition, the performance of the SCR reaction in the presence of SO₂ was measured using the catalysts of Examples 11, 12, and 13. Specifically, the performance of the above-described catalysts was measured under the same conditions as in FIG. 5B of Experimental Example 1, and the results of the nitrogen oxide conversion (NO_{X} conversion, X_{NOX}) are shown in FIG. 12B. All catalysts exhibited 100% N₂ selectivity in the temperature range of 150° C. to 300° C. Referring to FIG. 12A, it can be seen that when the crystal phase of the TM (cobalt) vanadate on which SO_{B}²⁻ and H_{3-A}PO₄^{A-} functional groups were immobilized was CoV₂O₆, the value of X_{NOX} was larger than that of Co₂V₂O₇, and when the crystal phase was Co₂V₂O₇, the value of X_{NOX} was larger than that of Co₃V₂O₈, in the absence of SO₂. In addition, referring to FIG. 12B, it can be seen that when the crystal phase of the TM (cobalt) vanadate on which SO_{B}²⁻ and H_{3-A}PO₄^{A-} functional groups were immobilized was CoV₂O₆, the value of X_{NOX} was larger than that of Co₂V₂O₇, and when the crystal phase was Co₂V₂O₇, the value of X_{NOX} was larger than that of Co₃V₂O₈, in the presence of SO₂. This means that in order to maximize the synergistic effect of SO_{B}²⁻ and H_{3-A}PO₄^{A-} inherent on the catalyst surface under various SCR reaction conditions, it is important to preferably select a TM (cobalt) vanadate crystal phase on which functional groups are immobilized.

### Experimental Example 9: Performance Analysis of SCR Reaction IX

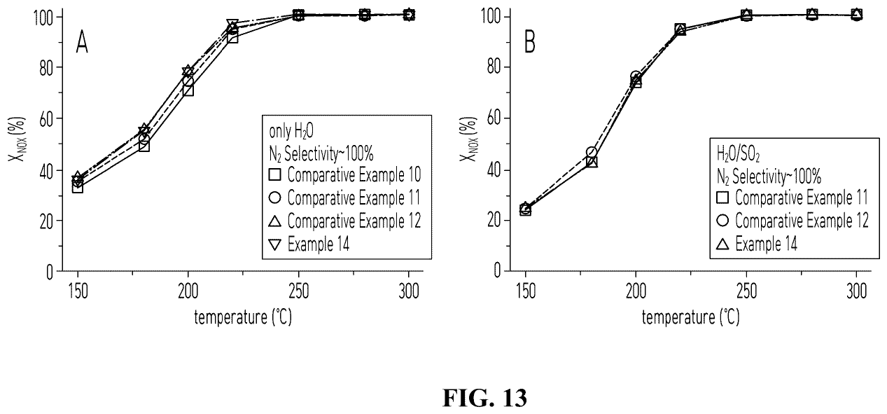

The performance of the SCR reaction in the absence of SO₂ was measured using the catalysts of Comparative Examples 10 to 12 and Example 14. Specifically, the performance of the above-described catalysts was measured under the same conditions as in FIG. 5A of Experimental Example 1, and the nitrogen oxide conversion (NO_{X} conversion, X_{NOX}) results are shown in FIG. 13A. In addition, the performance of the SCR reaction in the presence of SO₂ was measured using the catalysts of Comparative Examples 11 to 12 and Example 14. Specifically, the performance of the above-described catalysts was measured under the same conditions as in FIG. 5B of Experimental Example 1, and the nitrogen oxide conversion (NO_{X} conversion, X_{NOX}) results are shown in FIG. 13B. All catalysts exhibited 100% N₂ selectivity of in the temperature range of 150° C. to 300° C. Referring to FIG. 13A, it can be seen that the catalyst of Comparative Example 11 or Comparative Example 12, whose catalyst surface was functionalized with SO_{B}²⁻ or H_{3-A}PO₄^{A-}, exhibited larger X_{NOX} values at 150° C. to 300° C. than those of the catalyst of Comparative Example 10, whose catalyst surface was not functionalized. This means that the functionalization of the RM (lanthanum) vanadate with SO_{B}²⁻ or H_{3-A}PO₄^{A-} is effective in increasing the number of Brønsted acids for NH₃ adsorption, and that the SO_{B}²⁻ or H_{3-A}PO₄^{A-} functional groups are effective in increasing the redox cycling characteristics of the catalyst surface. In addition, it can be seen that the catalyst of Example 14, which was functionalized with SO_{B}²⁻ and H_{3-A}PO₄^{A-}, exhibited larger X_{NOX} values at 150° C. to 300° C. than those of the catalyst of Comparative Example 10 or Comparative Example 11, which were unfunctionalized or functionalized with SO_{B}²⁻. This means that the SO_{B}²⁻ and H_{3-A}PO₄^{A-} functional groups inherent on the surface of the RM (lanthanum) vanadate may have a synergistic effect in increasing the number of Brønsted acids for NH₃ adsorption and increasing the redox cycling characteristics of the catalyst surface. On the other hand, referring to FIG. 13A, it can be seen that the catalyst of Example 14 functionalized with SO_{B}²⁻ and H_{3-A}PO₄^{A-} exhibited similar X_{NOX} values at 150° C. to 300° C. to the catalyst of Comparative Example 12 functionalized with H_{3-A}PO₄^{A-}. In addition, referring to FIG. 13B, it can be seen that the catalyst of Comparative Example 11 functionalized with SO_{B}²⁻ the catalyst of Comparative Example 12 functionalized with H_{3-A}PO₄^{A-}, and the catalyst of Example 14 functionalized with SO_{B}²⁻ and H_{3-A}PO₄^{A-} exhibited similar X_{NOX} values at 150° C. to 300° C. This means that in order to maximize the synergistic effect of SO_{B}²⁻ and H_{3-A}PO₄^{A-} inherent on the catalyst surface, it is important to preferably control and select the functionalization conditions of SO_{B}²⁻ and H_{3-A}PO₄^{A-}, for example, the type of the TM vanadate, the concentrations of SO_{B}²⁻ and H_{3-A}PO₄^{A-} precursors (SO₂/O₂ and (NH₄)₂HPO₄), and the exposure time/exposure temperature to the catalyst surface.

### Experimental Example 10: Performance Analysis of SCR Reaction X

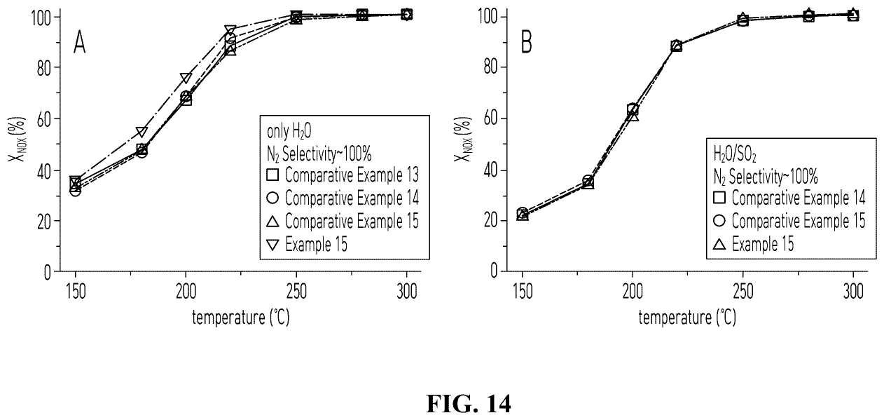

The performance of the SCR reaction in the absence of SO₂ was measured using the catalysts of Comparative Examples 13 to 15 and Example 15. Specifically, the performance of the above-described catalysts was measured under the same conditions as in FIG. 5A of Experimental Example 1, and the nitrogen oxide conversion (NO_{X} conversion, X_{NOX}) results are shown in FIG. 14A. In addition, the performance of the SCR reaction in the presence of SO₂ was measured using the catalysts of Comparative Examples 14 and 15 and Example 15. Specifically, the performance of the above-described catalysts was measured under the same conditions as in FIG. 5B of Experimental Example 1, and the nitrogen oxide conversion (NO_{X} conversion, X_{NOX}) results are shown in FIG. 14B. All catalysts exhibited 100% N₂ selectivity in the temperature range of 150° C. to 300° C. Referring to FIG. 14A, it can be seen that the X_{NOX} of the catalyst of Comparative Example 13, whose catalyst surface was not functionalized, at 150° C. 300° C., was similar to the X_{NOX} value of the catalysts of Comparative Example 14 or 15, whose catalyst surfaces were functionalized with SO_{B}²⁻ and H_{3-A}PO₄^{A-}. This means that the functionalization of the RM (lanthanum) vanadate by SO_{B}²⁻ and H_{3-A}PO₄^{A-} has a minimal effect in increasing the number of Brønsted acids for NH₃ adsorption, and that the SO_{B}²⁻ and H_{3-A}PO₄^{A-} functional groups have a minimal effect in increasing the redox cycling characteristics of the catalyst surface. On the other hand, it can be seen that the catalyst of Example 15 functionalized with SO_{B}²⁻ and H_{3-A}PO₄^{A-} exhibited larger X_{NOX} values at 150° C. to 300° C. than those of the catalysts of Comparative Example 13, which was unfunctionalized, Comparative Example 14, which was functionalized with SO_{B}²⁻ and Comparative Example 15, which was functionalized with H_{3-A}PO₄^{A-}. This means that the SO_{B}²⁻ and H_{3-A}PO₄^{A-} functional groups inherent on the surface of the RM metal (lanthanum) vanadate may have a synergistic effect in increasing the number of Brønsted acids for NH₃ adsorption and increasing the redox cycling characteristics of the catalyst surface. On the other hand, referring to FIG. 14B, it can be seen that the catalyst of Comparative Example 14 functionalized with SO_{B}²⁻ the catalyst of Comparative Example 15 functionalized with H_{3-A}PO₄^{A-}, and the catalyst of Example 15 functionalized with SO_{B}²⁻ and H_{3-A}PO₄^{A-} exhibited similar X_{NOX} values at 150° C. to 300° C. This means that in order to maximize the synergistic effect of SO_{B}²⁻ and H_{3-A}PO₄^{A-} inherent on the catalyst surface, it is important to preferably control and select the functionalization conditions of SO_{B}²⁻ and H_{3-A}PO₄^{A-}, for example, the type of the RM vanadate, the concentrations of SO_{B}²⁻ and H_{3-A}PO₄^{A-} precursors (SO₂/O₂ and (NH₄)₂HPO₄), and the exposure time/exposure temperature to the catalyst surface.

According to one embodiment of the present invention, a catalyst may be synthesized by dispersing one or more metal vanadates including a transition metal (Mn, Co, Ni, and Cu) or a rare-earth metal (La, Ce, Pr, Nd, Pm, Sm, Eu, Gd, Tb, Dy, Ho, Er, Tm, Yb, and Lu) as a catalytic site on the surface, and by applying an oxide of a Group 15 or 16 element as a promoter site or functionalizing some of the catalytic sites with H_{3-A}PO₄^{A-} and SO_{B}²⁻, to implement a catalytic surface having a high NO_{X} conversion rate and a high N₂ selectivity during selective catalytic NO_{X} reduction (SCR) operation.

In addition, based on the functionalization of the catalyst surface using H_{3-A}PO₄^{A-} and SO_{B}²⁻, 1) preferable interactions between acid sites/redox sites inherent in the catalytic site and NO_{X}, NH₃, and H₂O can be induced, 2) redox cycling characteristics can be improved, or 3) resistance to poisoning (H₂O, SO₂, ABS, and alkali-metal) or hydro-thermal aging that may occur during the SCR reaction can be enhanced. Based on these advantages, there is an effect of dramatically improve the performance and lifespan of the SCR catalyst.

It should be understood that the effects of the present invention are not limited to the above-described effects, but include all effects that may be inferred from the features of the invention described in the detailed description or claims of the present invention.

The above description of the present invention is for illustrative purposes, and those skilled in the art will understand that the present invention may be easily modified into other specific forms without changing the technical idea or essential characteristics of the present invention. Therefore, it should be understood that the above-described embodiments are illustrative in all respects and not restrictive. For example, each component described as a single component may be implemented in a distributed manner, and likewise, components described as distributed may be implemented in a combined manner.

The scope of the present invention is indicated by the claims set forth below, and all changes or modifications derived from the meaning and scope of the claims and their equivalent concepts should be interpreted as being included in the scope of the present invention.

What is claimed is:

1. A catalyst for nitrogen oxide reduction, comprising:
a catalyst site including one or more represented by Chemical Formulas 1 to 3 below; and
a support on which the catalyst site is supported;
wherein the catalyst site is functionalized with H_{3-A}PO₄^{A-} (A=1, 2, or 3) and SO_{B}²⁻ (B=3 or 4):
[Chemical Formula 1]
(TM)_{X}V₂O_{X+5} (X is 1, 2, or 3; TM is one or more selected from the group consisting of Mn, Co, Ni, and Cu)
[Chemical Formula 2]
(RM)VO₄ (RM is one or more selected from the group consisting of La, Ce, Pr, Nd, Pm, Sm, Eu, Gd, Tb, Dy, Ho, Er, Tm, Yb, and Lu)

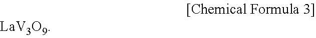

2. The catalyst for nitrogen oxide reduction of claim 1, further including a promoter site, which is an oxide of a Group 15 or 16 element, on the support.

3. The catalyst for nitrogen oxide reduction of claim 2, wherein the promotor site is included in an amount of 10⁻⁵% by weight to 50% by weight based on the support.

4. The catalyst for nitrogen oxide reduction of claim 2, wherein the Group 15 or 16 element is included in a combination of one or more of nitrogen (N), phosphorus (P), sulfur (S), arsenic (As), selenium (Se), antimony (Sb), tellurium (Te), bismuth (Bi), polonium (Po), moscovium (Mc), and livermorium (Lv).

5. The catalyst for nitrogen oxide reduction of claim 1, wherein the support includes one of carbon (C), Al₂O₃, MgO, ZrO₂, CeO₂, TiO₂, and SiO₂.

6. The catalyst for nitrogen oxide reduction of claim 1, wherein the transition metal vanadate or rare-earth metal vanadate represented by one or more of the Chemical Formulas 1 to 3 is each included in an amount of 10⁻⁵% by weight to 50% by weight based on 100% by weight of the support.

7. The catalyst for nitrogen oxide reduction of claim 1, wherein the support has a porous structure.

8. The catalyst for nitrogen oxide reduction of claim 1, wherein the catalytic site is a vanadate composed of Ni, V, and O;
an M/V molar ratio is 0.5 or more and 1.5 or less;
a P/(Sb+M+V) molar ratio is 10⁻² or more and 1.0 or less; and
a S/(Sb+M+V) molar ratio is 10⁻² or more and 1.0 or less, and
the M is Ni.

9. The catalyst for nitrogen oxide reduction of claim 1, wherein the catalytic site is a vanadate composed of Mn, V, and O;
an M/V molar ratio is 0.5 or more and 1.5 or less;
a P/(Sb+M+V) molar ratio is 10⁻² or more and 1.0 or less; and
an S/(Sb+M+V) molar ratio is 10⁻² or more and 1.0 or less, and
the M is Mn.

10. The catalyst for nitrogen oxide reduction of claim 1, wherein the catalytic site is a vanadate composed of Co, V, and O;
an M/V molar ratio is 0.5 or more and 1.5 or less;
a P/(Sb+M+V) molar ratio is 10⁻² or more and 1.0 or less; and
an S/(Sb+M+V) molar ratio is 10⁻² or more and 1.0 or less, and
the M is Co.

11. The catalyst for nitrogen oxide reduction of claim 1, wherein the catalytic site is a vanadate composed of La, V, and O;
an M/V molar ratio is 0.3 or more and 1.0 or less;
a P/(Sb+M+V) molar ratio is 10⁻² or more and 1.0 or less; and
an S/(Sb+M+V) molar ratio is 10⁻² or more and 1.0 or less, and
the M is La.

12. A synthesis method of a catalyst for nitrogen oxide reduction, the method comprising:
preparing a mixed solution by mixing a vanadium precursor solution and a rare-earth metal or transition metal precursor solution;
inputting a support to the mixed solution;
obtaining a solid after the inputting, and performing calcination; and
functionalizing a part of a rare-earth metal vanadate or a transition metal vanadate represented by at least one of Chemical Formulas 1 to 3 below with H_{3-A}PO₄^{A-} (A=1, 2, or 3) and SO_{B}²⁻ (B=3 or 4):
[Chemical Formula 1]
(TM)_{X}V₂O_{X+5} (X is 1, 2, or 3; TM is one or more selected from the group consisting of Mn, Co, Ni, and Cu)
[Chemical Formula 2]
(RM)VO₄ (RM is one or more selected from the group consisting of La, Ce, Pr, Nd, Pm, Sm, Eu, Gd, Tb, Dy, Ho, Er, Tm, Yb, and Lu)

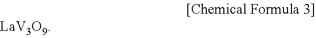

13. The synthesis method of a catalyst for nitrogen oxide reduction of claim 12, wherein the functionalizing with H_{3-A}PO₄^{A-} is performed by a reaction gas containing PH₃ and O₂.

14. The synthesis method of a catalyst for nitrogen oxide reduction of claim 13, wherein the concentrations of PH₃ and O₂ in the reaction gas have ranges of 10 ppm to 10⁵ ppm.

15. The synthesis method of a catalyst for nitrogen oxide reduction of claim 13, wherein the functionalizing with H_{3-A}PO₄^{A-} is performed at a flow rate of 10⁻⁵ mL·min⁻¹ to 10⁵ mL·min⁻¹ under pressure conditions of 10⁻⁵ bar to 10⁵ bar at a temperature of 100° C. to 800° C. for 0.1 to 24 hours.

16. The synthesis method of a catalyst for nitrogen oxide reduction of claim 12, wherein the functionalizing with H_{3-A}PO₄^{A-} consists of stirring and drying a synthetic solvent and the catalyst, wherein the synthetic solvent includes one or more of phosphoric acid (H₃PO₄), ammonium phosphate ((NH₄)₃PO₄), ammonium monohydrogen phosphate ((NH₄)₂HPO₄), ammonium dihydrogen phosphate (NH₄H₂PO₄), dimethyl phosphite ((CH₃O)₂HPO), diethyl phosphite ((C₂H₅O)₂HPO), trimethyl phosphite ((CH₃O)₃P), triethyl phosphite ((C₂H₅O)₃P), triisopropyl phosphite ((C₃H₇)₃P), and triphenyl phosphite ((C₆H₅O)₃P).

17. The synthesis method of a catalyst for nitrogen oxide reduction of claim 16, wherein the concentration of a phosphoric acid precursor contained in the synthetic solvent has a range of 10⁻⁵ mol·L⁻¹ to 10⁵ mol·L⁻¹.

18. The synthesis method of a catalyst for nitrogen oxide reduction of claim 16, wherein the stirring is performed for 0.1 to 24 hours.

19. The synthesis method of a catalyst for nitrogen oxide reduction of claim 12, wherein the functionalizing with SO_{B}²⁻ is performed by a reaction gas containing SO₂ and O₂.

20. The synthesis method of a catalyst for nitrogen oxide reduction of claim 19, wherein the concentrations of SO₂ and O₂ ppm in the reaction gas have ranges of 10 ppm to 10⁵.

21. The synthesis method of a catalyst for nitrogen oxide reduction of claim 19, wherein the functionalizing with SO_{B}²⁻ is performed at a flow rate of 10⁻⁵ mL·min⁻¹ to 10⁵ mL·min⁻¹ under pressure conditions of 10⁻⁵ bar to 10⁵ bar at a temperature of 100° C. to 800° C. for 0.1 to 24 hours.
